(19) United States
(12) Patent Application Publication
(10) Pub. No.: US 2026/0153470 A1
(43) Pub. Date: Jun. 4, 2026

(54) METHODS AND APPARATUS FOR MOISTURE CHARACTERIZATION

(71) Applicant: The Boeing Company, Arlington, VA (US)

(72) Inventors: Elias Eliot, Bengaluru (IN); Uddip Kashyap, Guwahati (IN); Khaarthik Jagadesan, Bengaluru (IN)

(21) Appl. No.: 18/968,642

(22) Filed: Dec. 4, 2024

(51) Int. Cl. G01N 27/22

(52) U.S. Cl. CPC G01N 27/223

(57) ABSTRACT

Methods and apparatus for moisture characterization are disclosed. A disclosed apparatus to determine a characteristic of moisture corresponding to a vehicle includes a moisture sensor including first and second insulative layers, first and second electrodes between the first and second insulative layers, and a liquid transport material, wherein at least a portion of the liquid transport material is positioned between the first and second electrodes, and a resonance circuit electrically coupled to the first and second electrodes, the resonance circuit to measure a capacitance of the moisture sensor.

### FIELD OF THE DISCLOSURE

This disclosure relates generally to vehicle monitoring and, more particularly, to methods and apparatus for moisture characterization.

### BACKGROUND

For aircraft, relatively low external temperatures at higher altitudes can cause moisture to condense within the internal structure of a fuselage. However, insulation systems control the movement of the moisture and direct the moisture away from the cabin and flight deck to a bilge where the moisture drains out from an aircraft via pressure drain valves.

Fuselage insulation blankets are typically implemented as a thermal and acoustic protection to isolate a cabin and passengers from external air temperature, ground, air, engine noise, etc. Conditions of the insulation blankets are typically checked during aircraft renovation activities, which usually occur every few years. Generally, there is no periodic maintenance practice specifically for identifying issues with an insulation blanket as well as fixing an inoperable or damaged insulation blanket. Additionally, when ground crews suspect damaged insulation blankets, interior panels are removed and/or disassembled to access the blankets for service and/or maintenance thereof.

### SUMMARY

An example apparatus to determine a characteristic of moisture corresponding to a vehicle includes a moisture sensor including first and second insulative layers, first and second electrodes between the first and second insulative layers, and a liquid transport material, wherein at least a portion of the liquid transport material is positioned between the first and second electrodes, and a resonance circuit electrically coupled to the first and second electrodes, the resonance circuit to measure a capacitance of the moisture sensor.

An example at least one non-transitory machine-readable medium includes machine-readable instructions to cause at least one processor circuit to at least determine a capacitance of a moisture sensor of a vehicle based on output from a circuit, the moisture sensor including (i) first and second electrodes between first and second insulative layers, and (ii) a liquid transport material, wherein at least a portion of the liquid transport material is positioned between the first and second electrodes, and determine a degree of moisture present in the vehicle based on the capacitance.

An example method includes determining, with a resonance circuit, a capacitance of a moisture sensor corresponding to a panel of a vehicle, the moisture sensor including (i) first and second electrodes between first and second insulative layers, and (ii) a liquid transport material, wherein at least a portion of the liquid transport material is positioned between the first and second electrodes, and determining a degree of moisture present in the panel based on the capacitance.

### BRIEF DESCRIPTION OF THE DRAWINGS

FIG. 1 illustrates an example aircraft in which examples disclosed herein can be utilized.

FIG. 2A is a cross-sectional view illustrating a moisture cycle of the aircraft of FIG. 1.

FIG. 2B illustrates an example process flow/method in accordance with teachings of this disclosure.

FIG. 3 illustrates an example moisture monitoring system in accordance with teachings of this disclosure.

FIG. 4 illustrates an example sensing arrangement in accordance with teachings of this disclosure.

FIG. 5 illustrates example implementations in accordance with teachings of this disclosure.

FIG. 6 is a schematic overview of an alternative example moisture monitoring system in accordance with teachings of this disclosure.

FIG. 7 is a schematic overview of example moisture sensing circuitry in accordance with teachings of this disclosure.

FIG. 8 is an example graph illustrating an example analysis in accordance with teachings of this disclosure.

FIG. 9 is a schematic overview of a moisture analysis system that can be implemented in examples disclosed herein.

FIGS. 10 and 11 are flowcharts representative of example machine readable instructions and/or example operations that may be executed, instantiated, and/or performed by example programmable circuitry to implement the example moisture monitoring system of FIG. 3 and/or the example moisture analysis system of FIG. 9.

FIG. 12 is a block diagram of an example processing platform including programmable circuitry structured to execute, instantiate, and/or perform the example machine readable instructions and/or perform the example operations of FIGS. 10 and 11 to implement the example moisture monitoring system of FIG. 3 and/or the example moisture analysis system of FIG. 9.

FIG. 13 is a block diagram of an example implementation of the programmable circuitry of FIG. 12.

FIG. 14 is a block diagram of another example implementation of the programmable circuitry of FIG. 12.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods and apparatus for moisture characterization are disclosed. For aircraft, a presence of excessive moisture in insulation blankets of fuselage panels can necessitate servicing. However, ascertaining a degree of moisture present in the insulation blankets typically requires disassembly and/or removal of components, which can involve service/maintenance time, as well as aircraft downtime. In contrast, examples disclosed herein enable automated (e.g., real-time assessment) of a health or operating condition of an insulation blanket without necessitating a time-consuming and costly maintenance procedure.

Examples disclosed herein can advantageously detect moisture (e.g., a degree of moisture saturation and/or ingress) to facilitate and improve cabin moisture management (CMM). According to other examples disclosed herein, relatively low external temperatures at high altitudes cause moisture to condense on the internal structure of the fuselage. To mitigate the moisture, insulation systems can control the movement of the moisture and direct the moisture away from a cabin and a flight deck to a bilge. As a result, the moisture can drain out from an aircraft via pressure drain valves (e.g., in a ground operation). The control of moisture involves designing the structure, insulation, and implementing felt seals to enable fluid (e.g., water) to drain to the aircraft bilge while preventing dripping into the cabin and onto electrical equipment.

Fuselage insulation blankets are generally implemented as a thermal and acoustic protection to isolate a cabin and passengers from external air temperature, ground, air, engine noise, etc. Insulation blankets can also mitigate the effects of moisture in the cabin by reducing and/or minimizing condensation formation by channeling any liquid/moisture formation away from the cabin and the passengers. In contrast to known systems, examples disclosed herein can determine or detect the moisture state or usability condition of the fuselage insulation blanket.

The process of a CMM cycle can be affected by: 1. passengers breathing (during flight) mixes with air in a cabin causing water vapor, 2. water vapor in the cabin air passes through gaps in insulation to a fuselage structure, 3. vapor contacts the cold structure and the water condenses in the form ice, 4. the structure warms and melts the ice as the aircraft descends for landing, and 5. water flows downward onto the outboard side of the insulation.

Moisture paths to aircraft skin and frame exist through insulation blanket overlaps, provisions within the blankets for secondary structures and wiring penetrations, as well as uninsulated structures and systems such as sub-frames and brackets. Moisture that is generated primarily from passengers and its movement through the crown and then between insulation blankets and airplane structure. Accordingly, frost formation, moisture ingress into the insulation blankets, potential moisture ingress into the cabin and frost melting and drainage can result. The moisture cycle can include three segments: 1. a condensation segment where frost forms on aircraft structure in this segment, 2. a drainage segment where accumulated frost melts and drains from airplane structure (e.g., unwanted water finds its way into a passenger compartment), and 3. a drying segment in which the CMM systems (insulation, felt pieces, and structures) shed some of the accumulated moisture. For aircraft, drying on the ground is the primary part of the drying segment, but drying can also occur during flight with proper air movement in a crown area of an aircraft.

A number of factors can influence the severity of condensation, efficiency of drainage and amount of drying that occurs in the aircraft moisture cycle. A greater number of passengers creates a greater moisture load. Cabin conditions such as air flow, cabin temperature, and relative humidity can have an effect on all of the aforementioned three segments of the moisture cycle. Design, installation, and maintenance quality of CMM related products are also impactful to all three moisture cycle segments. Other moisture cycle influencing factors are aircraft operating conditions, routes, utilization profile, weather, and ground operations practices such as usage of preconditioned air (PCA) to supply conditioned air to the cabin versus usage of accessory power unit (APU) for heating or cooling during ground time.

Rust development and metal deterioration can occur over time as a result of moisture that is developing in the insulation blankets and can potentially reach a metal surface. Further, a functional loss of insulation blankets can cause efficiency issues as the ECS will have to operate at a higher capacity to maintain a desired temperature.

Examples disclosed herein implement a detection mechanism for the moisture in the insulation blanket using a parasitic capacitance, which can enable detection of the moisture without necessitating disassembly of panels. Further, examples disclosed herein can implement a moisture relieving mechanism, component and/or system for the insulation blanket without disassembling the panel. Examples disclosed herein can utilize common (or the same) circuitry and/or wiring for parasitic capacitance to also supply heat externally, similar to a heating coil, which can evaporate moisture. In turn, the evaporated moisture can be removed with a high-powered vacuum that may be connected externally to the blanket via a vacuum port. In some examples, internet of things (IoT) devices can be utilized to ensure real-time data extraction and reporting. In particular, a maintenance crew may utilize a computing device (e.g., a portable device, a tablet, a mobile phone, a computer etc.) to identify a blanket that has a threshold degree of moisture and take action, if necessary.

Examples disclosed herein can be utilized with a fuselage, such as a skin, panel or wall of the fuselage, for example. Examples disclosed herein utilize a moisture sensor first and second electrodes positioned between first and second insulative layers, both of which may be implemented as insulation blankets. According to examples disclosed herein, liquid transport material, such as cotton for example, is positioned between the first and second electrodes. Further, an inductor-capacitor resonance circuit electrically coupled to the first and second electrodes is utilized to measure a capacitance (e.g., a parasitic capacitance) of the moisture sensor. In turn, the measured capacitance can be utilized for determination and/or characterization of moisture present in the skin or wall. According to some examples disclosed herein, a degree of moisture present in the skin or wall can be controlled (e.g., via a heater and/or vacuum) based on the measured capacitance.

Some examples disclosed herein can be utilized to control a degree of moisture present in a fuselage wall. In some such examples, a heating element can be controlled (e.g., automatically controlled) based on the degree of moisture present in the fuselage wall. Additionally or alternatively, a vacuum device is implemented to adjust the degree of moisture present (e.g., the vacuum device is controlled based on the determined degree of moisture). In some examples, a grid or array of sensor circuits is utilized for precise determination of a presence of moisture. For example, a specific blanket having a threshold degree of moisture can be identified (e.g., for service, maintenance, etc.). In some examples, ones of the sensor circuits can be utilized to heat specific areas to remove moisture, for example. In other words, examples disclosed herein can sense moisture (e.g., determine a degree of moisture present) as well as mitigate the same.

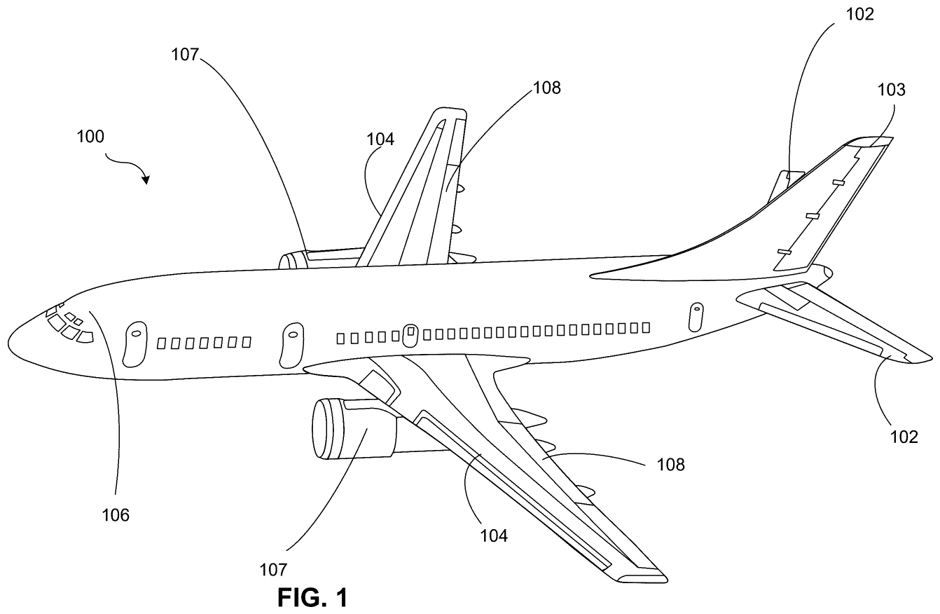

FIG. 1 illustrates an example aircraft 100 in which examples disclosed herein can be implemented. In particular, examples disclosed herein can be utilized to produce components and/or parts associated with the aircraft 100, for example. In the illustrated example of FIG. 1, the aircraft 100 includes horizontal tails 102, a vertical tail 103 and wings (e.g., fixed wings) 104 attached to a fuselage 106. The wings 104 of the illustrated example have engines 107, and control surfaces (e.g., flaps, ailerons, tabs, etc.) 108, some of which are located at a trailing edge or a leading edge of the wings 104. The control surfaces 108 may be displaced or adjusted (e.g., deflected, etc.) to provide lift during takeoff, landing and/or flight maneuvers.

In the illustrated example of FIG. 1, internal components and/or assemblies are located in the fuselage 106 (and other external components) of the aircraft 100. Examples disclosed herein can be applied to any appropriate internal or external structure and/or vehicle. Accordingly, examples disclosed herein can be utilized for rotorcraft, spacecraft, watercraft, submersibles, unmanned aerial vehicles, or stationary structures, etc. Examples disclosed herein can be utilized for any appropriate structure that can be adversely affected by excessive and/or uncontrolled moisture, for example. In a particular scenario, examples disclosed herein can effectively determine a degree of moisture present on a vehicle, for example. Examples disclosed herein can also work to regulate and/or mitigate moisture present in a vehicle, such as moisture present in portions and/or sections of a fuselage.

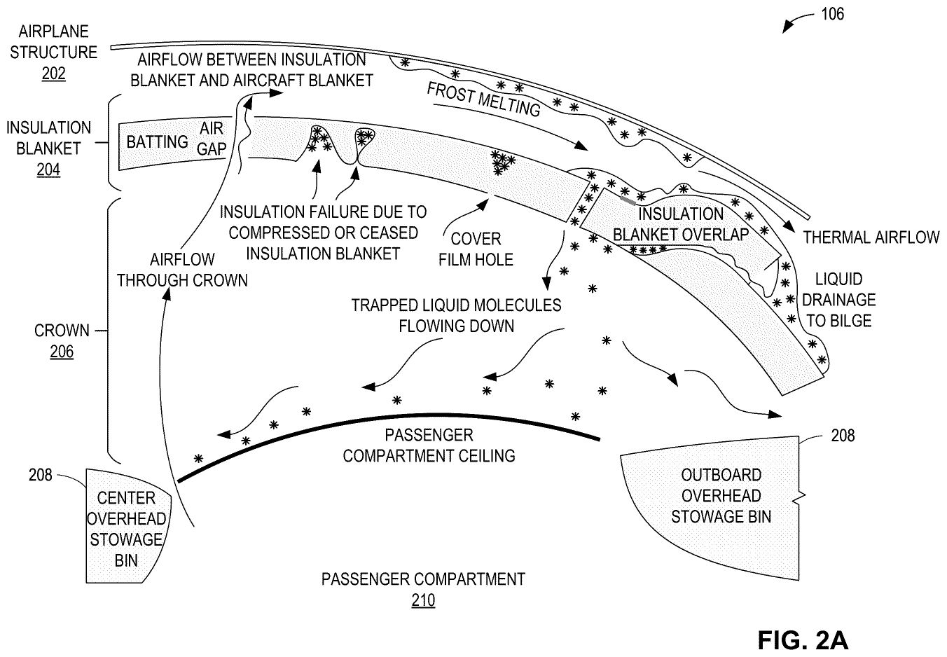

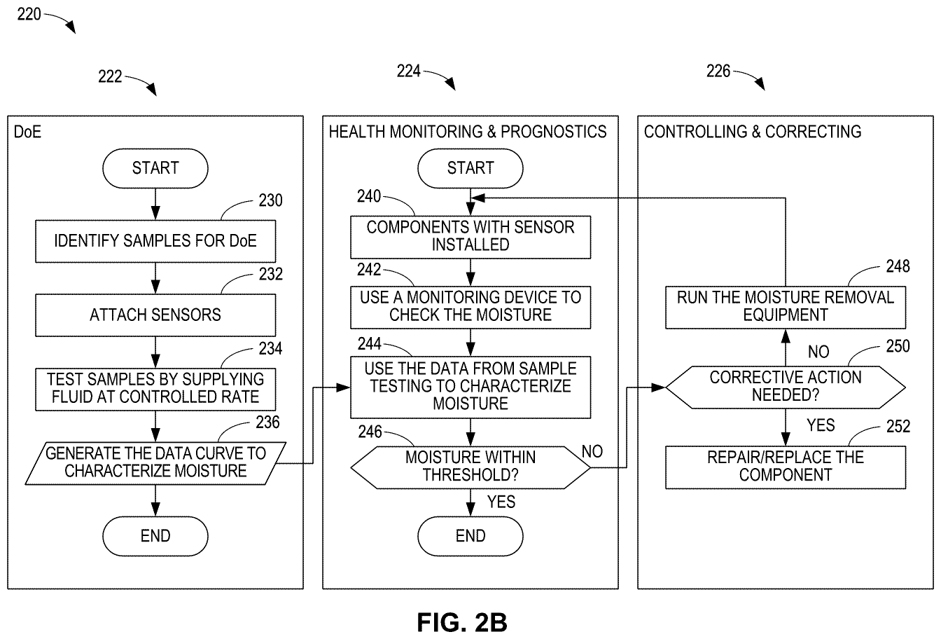

FIG. 2A is a cross-sectional view illustrating a moisture cycle of the fuselage 106 of the aircraft 100 shown in FIG. 1. In particular, the moisture cycle of FIG. 2A corresponds to a CMM management system. In the illustrated view of FIG. 2A, an exterior aircraft structure (e.g., a fuselage skin, an external panel, etc.) 202, an insulation blanket 204, a crown 206 and stowage bins 208 corresponding to a passenger compartment 210 are shown.

As can be seen in FIG. 2A, moisture from the passenger compartment 210 flows into the crown 206 and to the insulation blanket 204. In turn, the moisture in the crown 206 can cause at least a portion of the insulation blanket 204 to be compressed and/or creased. As the moisture makes its way to the exterior aircraft structure 202, frost formed on the exterior aircraft structure 202 then melts, thereby causing the moisture to condense and liquid to flow through and around the insulation blanket 204. A gap between the insulation blanket 204 and an adjacent insulation blanket can cause the liquid to flow back into the crown and/or the stowage bins 208 and, in turn, the passenger compartment 210 (e.g., and eventually drip into the passenger compartment 210).

FIG. 2B illustrates an example process flow/method 220 in accordance with teachings of this disclosure (depicted as a flowchart in FIG. 2B). In the illustrated example, a phase 222 related to design of experiments (DoE), a phase 224 related to health monitoring and prognostic, and phase 226 related to control/correction/mitigation.

At block 230 of the phase 222, samples are identified for a DoE. For example, components are identified and/or selected for characterization of moisture and/or moisture management of an aircraft (e.g., the aircraft 100). The DoE may be application dependent. In some examples, the DoE can be based on desired accuracy, characterization parameters, an application, a vehicle type, etc.

At block 232, in this example, sensors are attached and/or coupled to the components and/or samples identified for the DoE. According to some examples disclosed herein, the sensors are coupled/attached to components/samples that may be indicative of moisture conditions.

At block 234, according to examples disclosed herein, the aforementioned components/samples are tested with fluid and/or moisture that is supplied at a controlled and/or known rate.

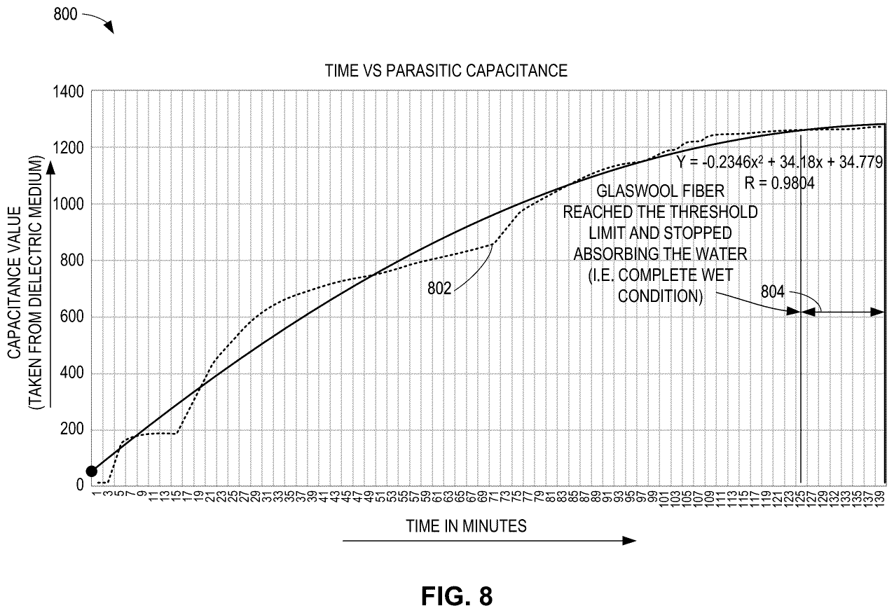

At block 236, a data curve is generated to characterize moisture with respect to the DoE, for example. According to some examples disclosed herein, the data curve can relate moisture with respect to time as shown and described below in connection with FIG. 8. According to examples disclosed herein, the data curve can be generated based on sensor sizing, operating conditions (e.g., operating temperature range, operating humidity, etc.), and sensor resolution.

At block 240, according to examples disclosed herein, the components/samples are in place for monitoring.

At block 242, a monitoring device is utilized to monitor the components/samples. For example, the monitoring device can be utilized to probe a section of a grid. Additionally or alternatively, the monitoring device can utilize and/or include an automated switching device/component between nodes/sections and/or the components/samples.

At block 244, in this example, the moisture is characterized. In this example, data from characterized sensors are utilized for characterization of the moisture.

At block 246, it is determined whether the moisture characterized is within a threshold and/or operating parameters. If the moisture is within the threshold and/or operating parameters (block 246), the process ends. Otherwise, the process proceeds to block 250.

At block 248, according to examples disclosed herein, moisture removal equipment and/or devices are operated/run. In some examples, a degree of moisture present is controlled.

At block 250, in some examples, it is determined whether corrective action is needed. If corrective action is needed (block 250), control of the process proceeds to block 252. Otherwise, the process proceeds to block 248.

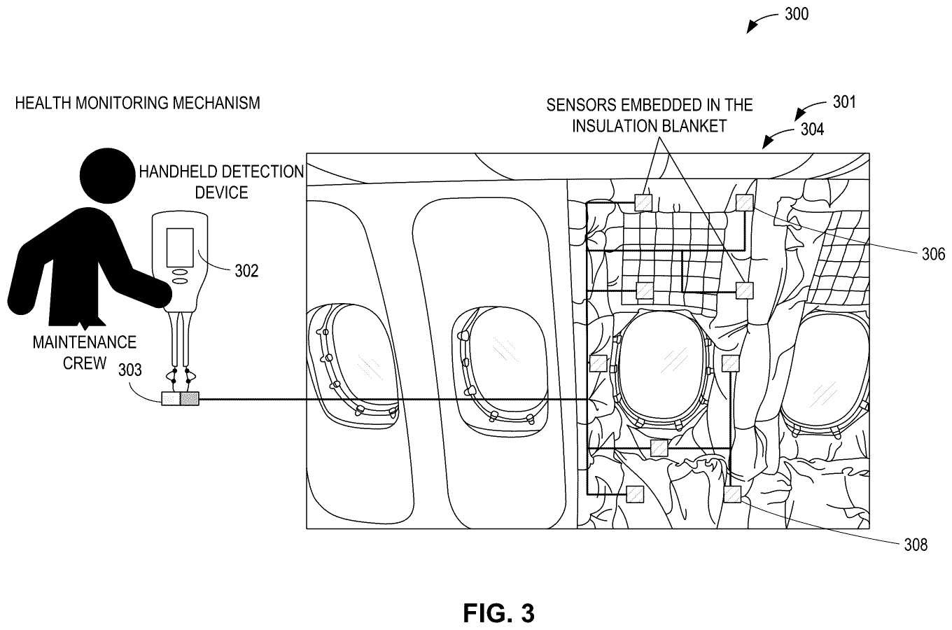

FIG. 3 illustrates an example moisture monitoring system 300 in accordance with teachings of this disclosure. The moisture monitoring system 300 of the illustrated example is to monitor a health (e.g., a moisture level) of an insulation blanket 301, and includes a detection device (e.g., a sensor device, a health monitoring device, etc.) 302, a detection node (e.g., an access grid, a measuring panel, an access circuit, etc.) 303 and a grid (e.g., an array, a circuit array, etc.) 304 of sensors (e.g., sensing elements, capacitive elements, sensing portions, etc.) 306 placed and/or spaced along different positions/locations of the insulation blanket 301. Further, the example grid 304 including wiring 308 to electrically couple the detection node and, in turn, the detection device 302 to the grid 304 of the sensors 306.

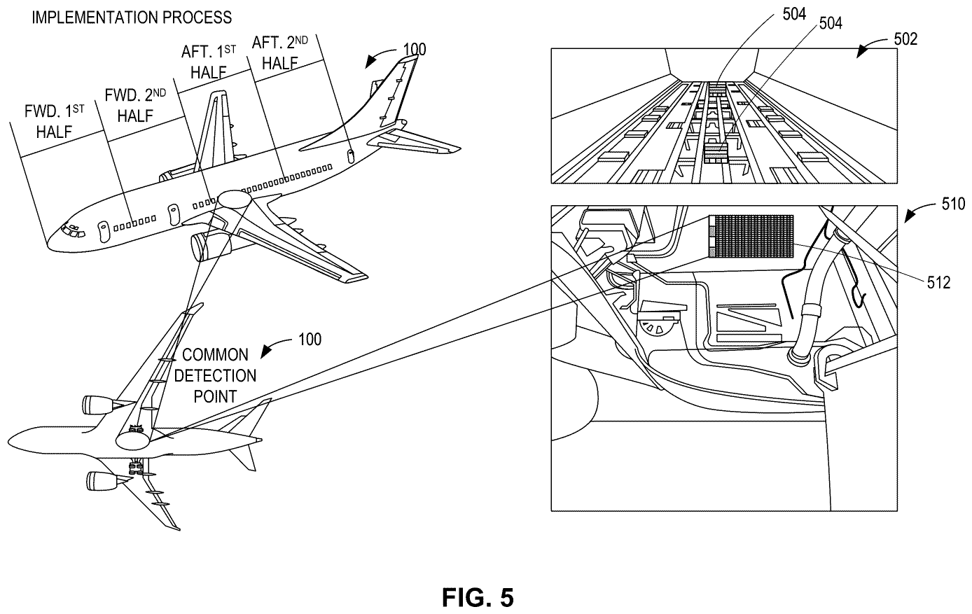

As will be discussed in greater detail below in connection with FIGS. 5-14, examples disclosed herein advantageously utilize sensing moisture in, around and/or proximate an insulation blanket (or other component/assembly/area) based on parasitic capacitance. In particular, the detection device 302 is utilized to determine a degree of moisture present in the blanket 301 by accessing the detection node 303 to measure a parasitic capacitance. Some examples disclosed herein can be utilized to identify an insulation blanket and/or a portion of the insulation blanket having a degree of moisture present that exceeds a threshold degree of moisture. Additionally or alternatively, some examples disclosed herein control and/or affect a degree of moisture present in an insulation blanket or a region surrounding or proximate the insulation blanket (e.g., via a heating device or a vacuum device). For example, the sensors 306 and/or circuitry associated therewith can be utilized to heat the insulation blanket (e.g., via a resistive element, via a sensing element, etc.),

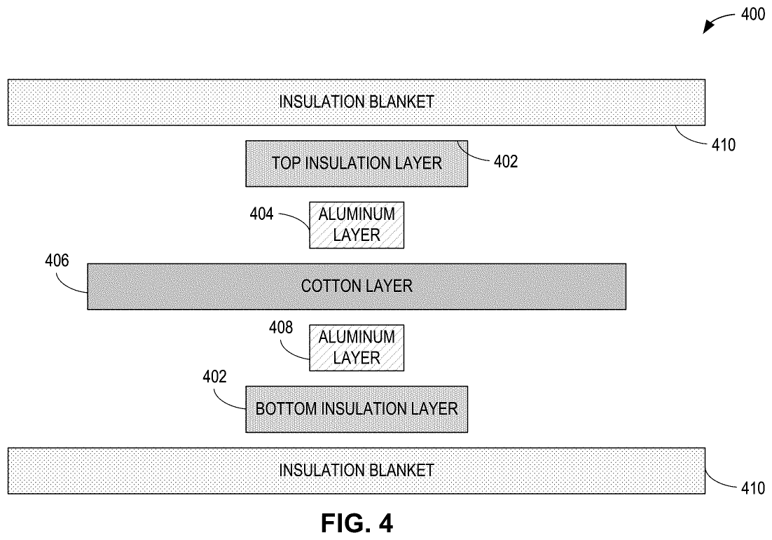

FIG. 4 illustrates an example sensing arrangement (e.g., a moisture sensor) 400 in accordance with teachings of this disclosure. Referring to FIG. 4, the sensing arrangement 400 is implemented onto and/or within a panel of a vehicle, such as a fuselage panel of an aircraft, for example. The illustrated view of FIG. 4 depicts the sensing arrangement 400 as a simplified layer representation. In this example, the sensing arrangement 400 includes a layered construction (e.g., an external skin layer, an insulation layer, a panel, etc.) having insulation layers (e.g., insulative layers) 402, a first conductor (e.g., a metal layer, an electrode layer, a conductor layer, etc.) 404, a liquid transport 406, a second conductor (e.g., a metal layer, an electrode layer, a conductor layer, etc.) 408, and insulation blankets 410. In this example, the sensing arrangement 400 is placed proximate, in contact with or at a target (e.g., a moisture target), which is an insulation blanket of a vehicle panel in this example. In particular, the example sensing arrangement may be positioned on a surface (e.g., an outer surface) of the insulation blanket or at least partially placed within (e.g. embedded within) the insulation blanket.

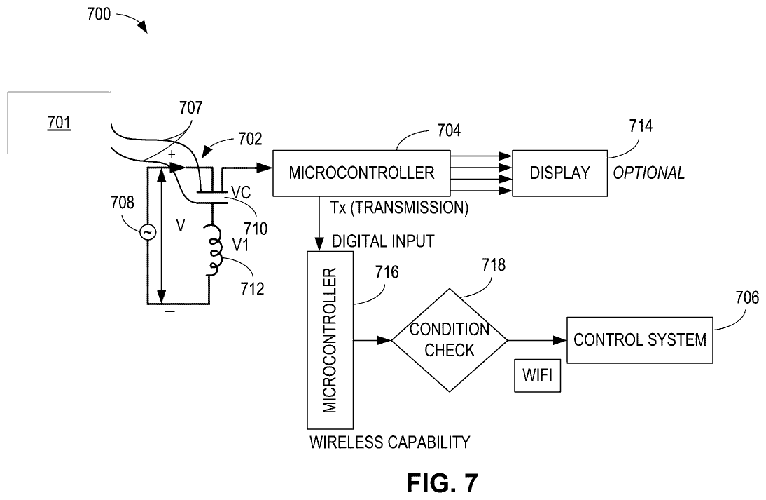

To measure a capacitance in an area/volume between the first conductor 404 and the second conductor 408, the sensing arrangement 400 of the illustrated example utilizes the first conductor 404 and the second conductor 408, both of which spaced apart from one another with at least a portion of the first liquid transport 406 positioned therebetween (e.g., the liquid transport 406 laterally extends in the view of FIG. 4 beyond the first conductor 404 and the second conductor 408). As shown below in connection with FIG. 7, the first conductor 404 and the second conductor 408 can be electrically coupled to a capacitor of an inductor-capacitor resonance circuit and moisture/liquid can be drawn/transported therebetween by the first liquid transport 406. Accordingly, the moisture present in the area between the first conductor 404 and the second conductor 408 affects capacitance measured at the capacitor of the inductor-capacitor resonance circuit. According to examples disclosed herein, the capacitance value can correspond to a degree of moisture present, characteristics of moisture transport, etc.

To facilitate movement of liquid from the aforementioned target, the liquid transport 406 is implemented for characterization of moisture present based on the parasitic capacitance. In this example, moisture/fluid/liquid from the target is drawn and/or transported to the first liquid transport 406, thereby affecting a capacitance measurement between the first conductor 404 and the second conductor 408.

FIG. 5 illustrates example implementations in accordance with teachings of this disclosure. In this example, the aircraft 100 is depicted to illustrate example positioning of sensors and/or sensor arrays in accordance with teachings of this disclosure. In view 502, a cargo lobe is shown having sensors (e.g., sensor arrays) 504 with corresponding detection grids positioned in a bilge. The example positions of the sensors 504 shown in view 502 can be advantageous for retrofitting.

In view 510, a sensor (e.g., a sensor array) 512 along with a detection grid is established in a wheel well. In some examples, at least one sensor is placed for insulation blankets between station lines of the aircraft 100. Further, a detection grid can be placed in a wheel well of an aircraft for example, thereby enabling maintenance crew to carry a handheld device (e.g., the detection device 302) therein to determine parasitic capacitance.

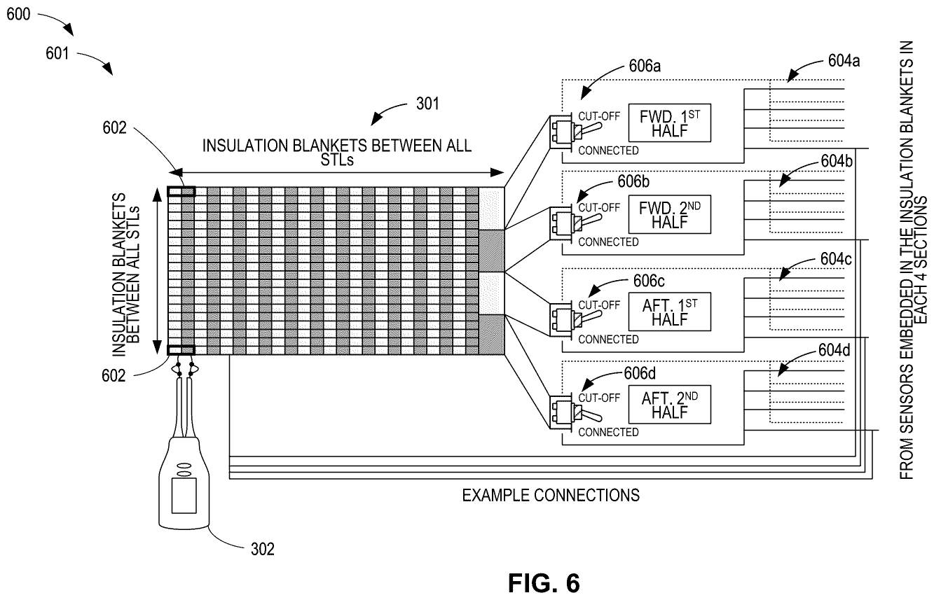

FIG. 6 is a schematic overview of an alternative example moisture detection system 600 in accordance with teachings of this disclosure. The example moisture detection system 600 includes the detection device 302 to interface with a grid 601 of detection nodes 602. In this example, sensors 604 (hereinafter sensors 604a, 604b, 604c, 604d) are embedded in insulation blankets of four aircraft sections, for example. In some examples, switches 606 (hereinafter switches 606a, 606b, 606c, 606d) are utilized to reduce a size and/or complexity of the grid 601 or other interface, for example.

FIG. 7 is a schematic overview of an example moisture sensing circuit 700 in accordance with teachings of this disclosure. The example moisture sensing circuit 700 includes a sensing portion 701 (e.g., the sensor(s) 306, the sensing arrangement 400) a detection circuit (e.g., a sensing circuit, an inductor-capacitor resonance circuit, etc.) 702, and a microcontroller 704. In some examples, the sensing portion 701 corresponds to an electrically coupled detection node. In some examples, the moisture sensing circuit 700 includes and/or is communicatively coupled to a vehicle control system 706, which is an aircraft control/monitoring system in this example.

The moisture sensing circuit 700 of the illustrated example includes at least one liquid moisture, which can implement and/or be coupled to the sensing arrangement 400 shown in FIG. 4. Further, in this example, leads 707 extend from the sending portion 701 to the aforementioned at least one moisture sensor. The moisture sensing circuit 700 includes a power/voltage source 708, a capacitor 710, and an inductor 712. In this example, the capacitor 710 is in series with the inductor 712, and parallel to the power/voltage source 708. In turn, the moisture sensing circuit 700 is electrically coupled to the example microcontroller 704 and, in some examples, a display 714. In the illustrated example of FIG. 7, a microcontroller 716 is communicatively coupled to the microcontroller 704 and a condition check 718 that is in wireless communication the aforementioned vehicle control system 706 (e.g., via Wi-Fi, Bluetooth or other communication protocol).

In operation, the aforementioned leads 707 are electrically coupled to conductors (e.g., conductor plates, conductor leads, etc.) associated with at least one sensor and/or sensing element (e.g., the sensing arrangement 400). In this example, the microcontroller 704 and/or the microcontroller 716 includes and/or causes a transmitter to transmit output corresponding to capacitance (e.g., a parasitic capacitance) of the at least one sensor and/or sensing element. According to examples disclosed herein, the microcontroller 716 is to analyze and/or utilize the output from the microcontroller 704 and the condition check 718 utilizes the output to determine a condition associated with an insulation blanket and/or an associated vehicle area/component/device/assembly, for example.

FIG. 8 is an example graph 800 illustrating an example analysis in accordance with teachings of this disclosure. The example graph 800 relates capacitance as a function of time. In this particular example, at approximately a time of 0 minutes, an insulation blanket is in a completely dry condition. Further, an inflection point 802 corresponds to a time when liquid (e.g., water) is absorbed into a glass wool material while point 804 corresponds to a time at which the glass wool material has reached a threshold absorption limit (e.g., a saturation point) and, thus, ceases to further absorb the liquid.

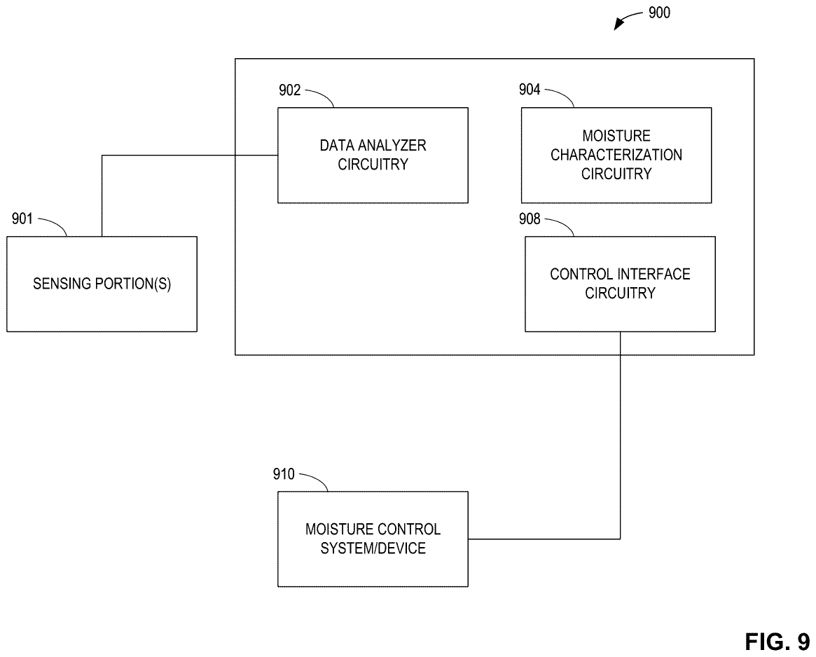

FIG. 9 is a block diagram of an example implementation of an example moisture analysis system 900 to analyze and/or characterize a presence of moisture. The example moisture analysis system 900 can be utilized to implement and/or at least partially implement the example process flow/method 220 shown in FIG. 2B. The moisture analysis system 900 of FIG. 9 may be instantiated (e.g., creating an instance of, bring into being for any length of time, materialize, implement, etc.) by programmable circuitry such as a Central Processor Unit (CPU) executing first instructions. Additionally or alternatively, the moisture analysis system 900 of FIG. 9 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 9 may, thus, be instantiated at the same or different times. Some or all of the circuitry of FIG. 9 may be instantiated, for example, in one or more threads executing concurrently on hardware and/or in series on hardware. Moreover, in some examples, some or all of the circuitry of FIG. 9 may be implemented by microprocessor circuitry executing instructions and/or FPGA circuitry performing operations to implement one or more virtual machines and/or containers.

The example moisture analysis system 900 of the illustrated example is electrically coupled to a sensing portion 901, which can include the sensing arrangement shown in FIG. 4 along with the example circuitry shown in FIG. 7. The example moisture analysis system 900 moisture analysis system 900 includes example data analyzer circuitry 902, example moisture characterization circuitry 904, and example control interface circuitry 908. Further, the moisture analysis system 900 can be part of, include and/or be communicatively coupled to a moisture control system/device 910. The moisture control system/device 910 can include, but is not limited to, a heater, a vacuum device, a suction device, a fan, a compressor, etc.

The example data analyzer circuitry 902 is utilized to process. characterize and/or analyze data corresponding to the sensing portion 901, which may be selected by the switches 606 shown in FIG. 6. In this example, the data analyzer circuitry 902 utilizes output and/or signals from the sensing arrangement portion 901 to determine a parasitic capacitance thereof. In particular, the parasitic capacitance can vary based on characteristics of fluid/moisture present between contacts of the sensing arrangement 400. In some examples, the data analyzer circuitry 902 is instantiated by programmable circuitry executing data analyzer instructions and/or configured to perform operations such as those represented by the flowcharts of FIGS. 2B, 10 and 11.

The moisture characterization circuitry 904 of the illustrated example determines a degree of moisture present based on the aforementioned parasitic capacitance. According to examples disclosed herein, the moisture characterization circuitry 904 can generate a curve, a graph and/or a data array associated with the parasitic capacitance for determination and/or characterization of a presence of moisture. In some examples, a curve that relates parasitic capacitance with respect to time is generated (e.g., a parasitic capacitance history). In some such examples, a slope of the curve can be utilized to determine characteristics of the moisture (e.g., a degree of moisture present).

An example calculation that can be performed by the moisture characterization circuitry 904 is illustrated below. In this example, two conductor plates have an overlapping area al, and surface charge density ±σ are placed parallel to each other as shown schematically in the example of FIG. 4. The total electric field generates when the relative permeability constant β=1 is given by example Equation 1 and can yield example Equation 2:

$${E}_{0} = 4 π k σ \qquad ( 1 )$$

$$k = \frac{1}{4 {πε}_{0}} , \qquad ( 2 )$$

where, ε₀=8.85×10⁻¹² C²N⁻¹m⁻². In this example, a dielectric plate of thickness d is used in between such that both of the conductor plates. The positioning of the dielectric plate between the conductor plate polarizes the dielectric plate. As a result, ±σ′ develops adjacent to the conductor plates. As a result, the electric field E₀ is produced between the two conductor plates with relatively no dielectric medium (β=1). Therefore, the changed electric field can be expressed by example Equations 3-5 below:

$$E = 4 π k σ - 4 π k {σ}^{′} \qquad ( 3 )$$

$$E = {E}_{0} ( 1 - \frac{σ′}{σ} ) \qquad ( 4 )$$

$$E = \frac{{E}_{0}}{β} \qquad ( 5 )$$

In turn, the relative permeability constant #can be defined with example Equation 6 below:

$$\frac{1}{β} = 1 - \frac{σ′}{σ} \qquad ( 6 )$$

The total amount of charge present over the conductor plate is defined by Q. The electric field extends in a generally perpendicular direction from the plate up to infinity. However, the strength decreases as it moves away from the plate. Accordingly, it can be assumed that at infinity, E=0. Due to the developed electric field, voltage evolves such that voltage at infinity is V∞=0. In turn, as the variation in charge Q with V∞ follows a linear profile extending to infinity, a ratio of charge, Q to voltage, V yields capacitance, C at that point, as shown by example Equation 7:

$$C = \frac{Q}{V} \qquad ( 7 )$$

With the increase in the value of β, voltage decreases, which results in the increment in the initial capacitance value C₀ by a factor β as shown in example Equation 8 below:

$$C = β \times {C}_{0} \qquad ( 8 )$$

Quantitative evaluation of capacitance can be obtained if the type of the dielectric area α₁ and thickness of the dielectric d are known as shown in example Equation 9 below:

$$. C = \frac{{βε}_{0} {α}_{1}}{d} \qquad ( 9 )$$

Therefore, capacitance is directly proportional to the area of the conductor α₁ and inversely proportional to the separation distance d. The constant of proportionality is βε₀. The parameter, βε₀ depends on the type of dielectric and conductor material used as described by example Equation 6. As a result, the evaluation of βε₀ can be utilized for determining and/or characterizing capacitance of a system.

According to examples disclosed herein, the capacitance value is directly proportional to the change in dielectric constant of the cotton layer between an aluminum layer, for example, with the introduction of moisture and/or liquid. As a result, the updated capacitance can be calculated as per example Equation 9. In some examples, a detection module can monitor and report the output value of the capacitance periodically (e.g., every 10 seconds, every minute, every 5 minutes, . . . etc.). If a value of capacitance is increased, moisture is determined to be present and/or detected. A slope of a capacitance curve can be calculated and, in turn, an estimation of time of operation before failure moisture saturation is predicted. The slope of the curve may be based on analyzing a shape of the curve, for example. Additionally or alternatively, a degree of excess moisture and/or moisture saturation is determined. The example described above is only an example and any other appropriate methodology and/or calculation can be implemented instead.

In some examples, the moisture characterization circuitry 904 is instantiated by programmable circuitry executing moisture characterization instructions and/or configured to perform operations such as those represented by the flowcharts of FIGS. 2B, 10 and 11.

In some examples, the control interface circuitry 908 is implemented to control and/or direct of a system, such as the moisture control system device 910, which can be implemented as a moisture management device, a CMM device, a heater, a vacuum, fluid vents, etc., based on a degree of moisture present. In some examples, the moisture characterization circuitry 904 can direct and/or provide information (e.g., moisture presence information, moisture characterization information, a degree of moisture present, etc.) to a vehicle control system, such as the vehicle control system 706 shown in FIG. 7. According to examples disclosed herein, the control interface circuitry 908 may cause a transmitter and/or transceiver to wirelessly transmit the information to the vehicle control system 706. In some examples, the control interface circuitry 908 is instantiated by programmable circuitry executing control interface circuitry instructions and/or configured to perform operations such as those represented by the flowcharts of FIGS. 2B, 10 and 11.

While an example manner of implementing the moisture analysis system 900 of FIG. 9 is illustrated in FIG. 9, one or more of the elements, processes, and/or devices illustrated in FIG. 9 may be combined, divided, re-arranged, omitted, eliminated, and/or implemented in any other way. Further, the example data analyzer circuitry 902, the example moisture characterization circuitry 904, the example control interface circuitry 908, and/or, more generally, the example moisture analysis system 900 of FIG. 9, may be implemented by hardware alone or by hardware in combination with software and/or firmware. Thus, for example, any of the example data analyzer circuitry 902, the example moisture characterization circuitry 904, the example control interface circuitry 908, and/or, more generally, the example moisture analysis system 900, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example moisture analysis system 900 of FIG. 9 may include one or more elements, processes, and/or devices in addition to, or instead of, those illustrated in FIG. 9, and/or may include more than one of any or all of the illustrated elements, processes and devices.

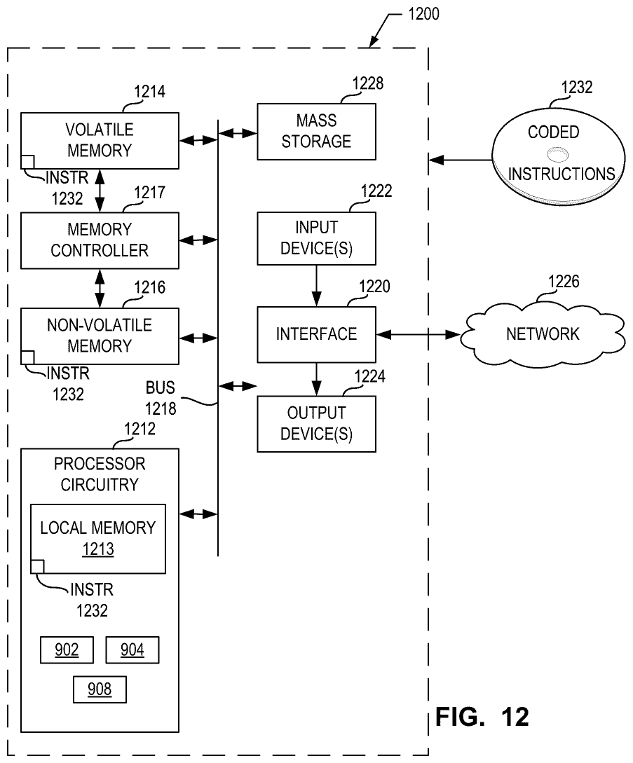

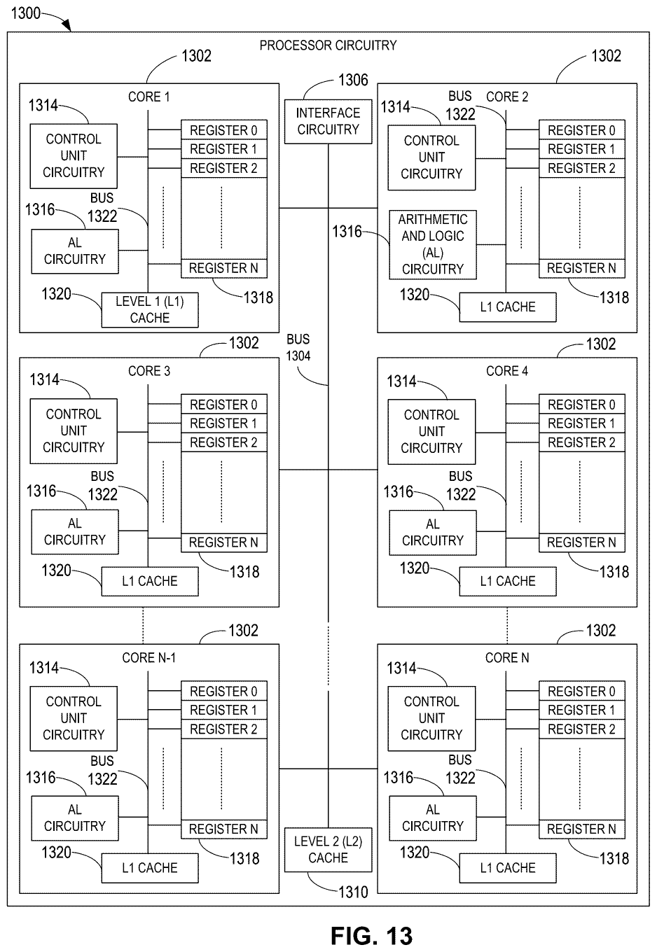

Flowcharts representative of example machine readable instructions, which may be executed by programmable circuitry to implement and/or instantiate the moisture analysis system 900 of FIG. 9 and/or representative of example operations which may be performed by programmable circuitry to implement and/or instantiate the moisture analysis system 900 of FIG. 9, are shown in FIGS. 2B.10 and 11. The machine readable instructions may be one or more executable programs or portion(s) of one or more executable programs for execution by programmable circuitry such as the programmable circuitry 1212 shown in the example processor platform 1200 discussed below in connection with FIG. 12 and/or may be one or more function(s) or portion(s) of functions to be performed by the example programmable circuitry (e.g., an FPGA) discussed below in connection with FIGS. 13 and/or 14. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 2B, 10 and 11, many other methods of implementing the example moisture analysis system 900 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2B, 10 and 11 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

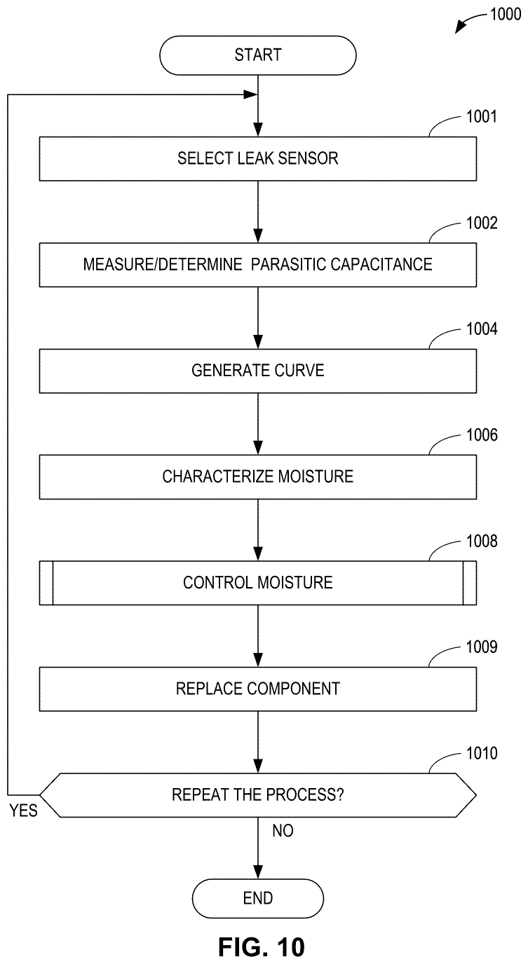

FIG. 10 is a flowchart representative of example machine readable instructions and/or example operations 1000 that may be executed, instantiated, and/or performed by programmable circuitry to identify and/or characterize moisture in a system The example machine-readable instructions and/or the example operations 1000 of FIG. 10 begin at block 1001, at which the example data analyzer circuitry 902 selects and/or identifies a sensor (e.g., a sensor of an array, a sensing element, a sensor cluster, a sensor group, etc. etc.) of a vehicle to obtain signals therefrom. For example, the data analyzer circuitry 902 may determine and/or select a group of sensors/sensor elements to determine a presence of moisture.

At block 1002, the data analyzer circuitry 902 of the illustrated example measures, causes measurement of and/or determines the parasitic capacitance via a sensing circuit (e.g., the sensing circuit 702 of FIG. 7).

At block 1004, the example moisture characterization circuitry 904 generates a curve. In this example, the moisture characterization circuitry 904 generates a curve that relates a capacitance and/or a slope of capacitance with respect to time. In some examples, the moisture characterization circuitry 904 identifies and/or characterizes a linear portion, a beginning, an end and/or an inflection point of the curve.

At block 1006, the moisture characterization circuitry 904 of the illustrated example characterizes moisture present in the vehicle. In this example, the moisture characterization circuitry 904 determines a degree of moisture present in a region of the vehicle with an insulation blanket.

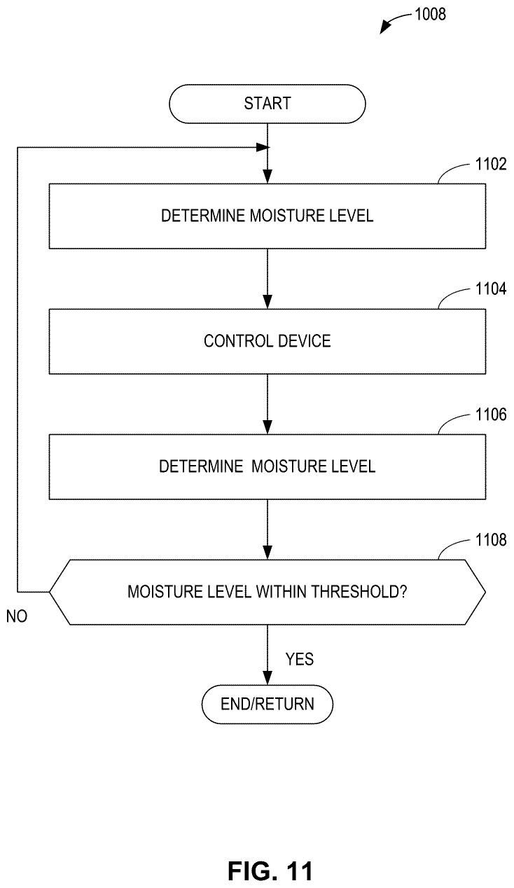

At block 1008, as will be discussed below in connection with FIG. 11, the control interface circuitry 908 controls the moisture control system/device 910 based on the characterized moisture. In some examples, the control interface circuitry 908 directs and/or controls a heater device, an air movement device (e.g., a fan) and/or a vacuum device to control a degree of moisture present.

At block 1009, in some examples, the example moisture characterization circuitry 904 can cause and/or provide an indication to replace and/or service a component. For example, the determination may be based on the characterized moisture and/or a result of controlling the moisture control/device 910.

At block 1010, it is determined by the example moisture characterization circuitry 904 as to whether to repeat the process. If the process is to be repeated (block 1010), control of the process returns to block 1001. Otherwise, the process ends. The determination may be based on whether additional monitoring of moisture is necessitated or desired, whether a moisture level is within specification/operating limits.

FIG. 11 is a flowchart representative of the example machine readable instructions and/or example operations 1008 that may be executed, instantiated, and/or performed by programmable circuitry to identify and/or characterize moisture in a system of the vehicle. The example machine-readable instructions and/or the example operations 1008 of FIG. 11 begin at block 1102, at which the example the control interface circuitry 908 determines the moisture level (e.g., moisture present in the insulation blanket). The determination may be based on the characterization of the moisture performed by the moisture characterization circuitry 904.

At block 1104, the control interface circuitry 908 controls the moisture control system/device 910 based on the determined moisture level. In some examples, the control interface circuitry 908 the control interface circuitry 908 determines a setpoint of a heater, a vacuum device, a fan or other moisture control device for control thereof.

At block 1106, the control interface circuitry 908 determines the moisture level and/or moisture characterization subsequent to or during control of the moisture control system/device 910.

At block 1108, the control interface circuitry 908 determines whether the moisture level and/or the moisture characterization is within a threshold (e.g., above or below a threshold level, within a threshold range, etc.). If the process is to be repeated (block 1108), control of the process returns to block 1102. Otherwise, the process ends/returns.

Any aspect and/or implementation shown and described in FIG. 2B can be implemented in the examples of FIG. 10 and/or FIG. 11.

FIG. 12 is a block diagram of an example programmable circuitry platform 1200 structured to execute and/or instantiate the example machine-readable instructions and/or the example operations of FIGS. 2B, 10 and 11 to implement the moisture analysis system 900 of FIG. 9. The programmable circuitry platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1200 of the illustrated example includes programmable circuitry 1212. The programmable circuitry 1212 of the illustrated example is hardware. For example, the programmable circuitry 1212 can be implemented by one or more integrated circuits, logic circuits, FPGAs, microprocessors, CPUs, GPUs, DSPs, and/or microcontrollers from any desired family or manufacturer. The programmable circuitry 1212 may be implemented by one or more semiconductor based (e.g., silicon based) devices. In this example, the programmable circuitry 1212 implements the example data analyzer circuitry 902, the example moisture characterization circuitry 904, and the example control interface circuitry 908.

The programmable circuitry 1212 of the illustrated example includes a local memory 1213 (e.g., a cache, registers, etc.). The programmable circuitry 1212 of the illustrated example is in communication with main memory 1214, 1216, which includes a volatile memory 1214 and a non-volatile memory 1216, by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217. In some examples, the memory controller 1217 may be implemented by one or more integrated circuits, logic circuits, microcontrollers from any desired family or manufacturer, or any other type of circuitry to manage the flow of data going to and from the main memory 1214, 1216.

The programmable circuitry platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user (e.g., a human user, a machine user, etc.) to enter data and/or commands into the programmable circuitry 1212. The input device(s) 1222 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1200 of the illustrated example also includes one or more mass storage discs or devices 1228 to store firmware, software, and/or data. Examples of such mass storage discs or devices 1228 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1232, which may be implemented by the machine readable instructions of FIGS. 2B, 10 and 11, may be stored in the mass storage device 1228, in the volatile memory 1214, in the non-volatile memory 1216, and/or on at least one non-transitory computer readable storage medium such as a CD or DVD which may be removable.

FIG. 13 is a block diagram of an example implementation of the programmable circuitry 1212 of FIG. 12. In this example, the programmable circuitry 1212 of FIG. 12 is implemented by a microprocessor 1300. For example, the microprocessor 1300 may be a general-purpose microprocessor (e.g., general-purpose microprocessor circuitry). The microprocessor 1300 executes some or all of the machine-readable instructions of the flowcharts of FIGS. 2B, 10 and 11 to effectively instantiate the circuitry of FIG. 9 as logic circuits to perform operations corresponding to those machine readable instructions. In some such examples, the circuitry of FIG. 9 is instantiated by the hardware circuits of the microprocessor 1300 in combination with the machine-readable instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 2B, 10 and 11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating-point operations. In yet other examples, the AL circuitry 1316 may include first AL circuitry that performs integer-based operations and second AL circuitry that performs floating-point operations. In some examples, the AL circuitry 1316 may be referred to as an Arithmetic Logic Unit (ALU).

The registers 1318 are semiconductor-based structures to store data and/or instructions such as results of one or more of the operations performed by the AL circuitry 1316 of the corresponding core 1302. For example, the registers 1318 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure, such as by being distributed throughout the core 1302 to shorten access time. The second bus 1322 may be implemented by at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages.

The microprocessor 1300 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1300, in the same chip package as the microprocessor 1300 and/or in one or more separate packages from the microprocessor 1300.

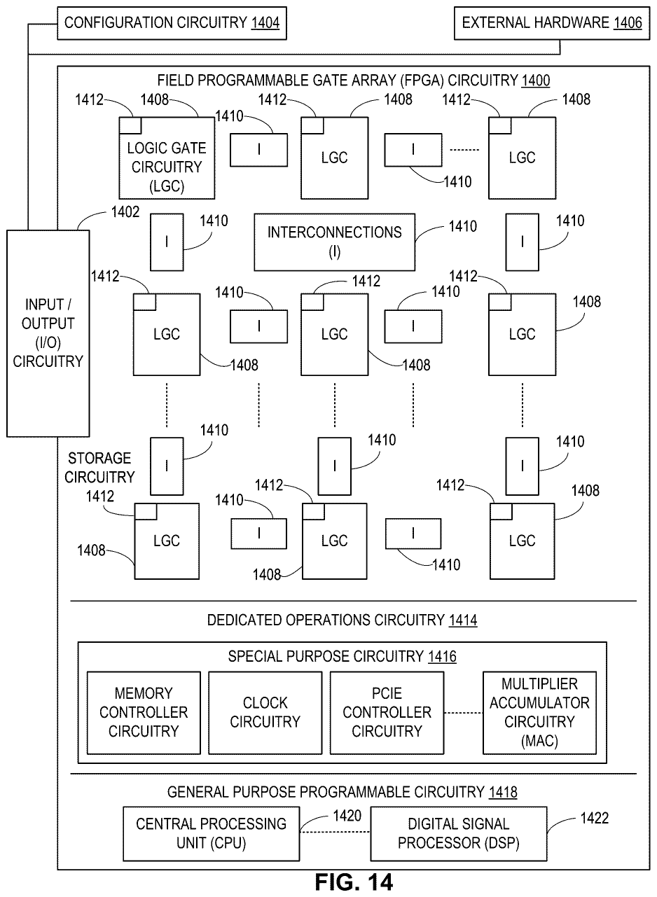

FIG. 14 is a block diagram of another example implementation of the programmable circuitry 1212 of FIG. 12. In this example, the programmable circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 2B, 10 and 11 but whose interconnections and logic circuitry are fixed once fabricated), the FPGA circuitry 1400 of the example of FIG. 14 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 2B, 10 and 11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 2B, 10 and 11. As such, the FPGA circuitry 1400 may be configured and/or structured to effectively instantiate some or all of the operations/functions corresponding to the machine readable instructions of the flowcharts of FIGS. 2B, 10 and 11 as dedicated logic circuits to perform the operations/functions corresponding to those software instructions in a dedicated manner analogous to an ASIC. Therefore, the FPGA circuitry 1400 may perform the operations/functions corresponding to the some or all of the machine readable instructions of FIGS. 2B, 10 and 11 faster than the general-purpose microprocessor can execute the same.

In the example of FIG. 14, the FPGA circuitry 1400 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1400 of FIG. 14 may access and/or load the binary file to cause the FPGA circuitry 1400 of FIG. 14 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1400 of FIG. 14 to cause configuration and/or structuring of the FPGA circuitry 1400 of FIG. 14, or portion(s) thereof.

The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain a binary file, which may be implemented by a bit stream, data, and/or machine-readable instructions, to configure the FPGA circuitry 1400, or portion(s) thereof. In some such examples, the configuration circuitry 1404 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1406 may be implemented by external hardware circuitry. For example, the external hardware 1406 may be implemented by the microprocessor 1300 of FIG. 13.

The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations/functions that may correspond to at least some of the machine readable instructions of FIGS. 2B, 10 and 11 and/or other desired operations. The logic gate circuitry 1408 shown in FIG. 14 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations/functions. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example dedicated operations circuitry 1414. In this example, the dedicated operations circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the programmable circuitry 1212 of FIG. 12, many other approaches are contemplated. For example, FPGA circuitry may include an on-board CPU, such as one or more of the example CPU 1420 of FIG. 13. Therefore, the programmable circuitry 1212 of FIG. 12 may additionally be implemented by combining at least the example microprocessor 1300 of FIG. 13 and the example FPGA circuitry 1400 of FIG. 14. In some such hybrid examples, one or more cores 1302 of FIG. 13 may execute a first portion of the machine readable instructions represented by the flowcharts of FIGS. 2B, 10 and 11 to perform first operation(s)/function(s), the FPGA circuitry 1400 of FIG. 14 may be configured and/or structured to perform second operation(s)/function(s) corresponding to a second portion of the machine readable instructions represented by the flowcharts of FIGS. 2B, 10 and 11, and/or an ASIC may be configured and/or structured to perform third operation(s)/function(s) corresponding to a third portion of the machine readable instructions represented by the flowcharts of FIGS. 2B, 10 and 11.

It should be understood that some or all of the circuitry of FIG. 9 may, thus, be instantiated at the same or different times. For example, same and/or different portion(s) of the microprocessor 1300 of FIG. 13 may be programmed to execute portion(s) of machine-readable instructions at the same and/or different times. In some examples, same and/or different portion(s) of the FPGA circuitry 1400 of FIG. 14 may be configured and/or structured to perform operations/functions corresponding to portion(s) of machine-readable instructions at the same and/or different times.

In some examples, some or all of the circuitry of FIG. 9 may be instantiated, for example, in one or more threads executing concurrently and/or in series. For example, the microprocessor 1300 of FIG. 13 may execute machine readable instructions in one or more threads executing concurrently and/or in series. In some examples, the FPGA circuitry 1400 of FIG. 14 may be configured and/or structured to carry out operations/functions concurrently and/or in series. Moreover, in some examples, some or all of the circuitry of FIG. 9 may be implemented within one or more virtual machines and/or containers executing on the microprocessor 1300 of FIG. 13.

In some examples, the programmable circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the programmable circuitry 1212 of FIG. 12, which may be in one or more packages. For example, the XPU may include a CPU (e.g., the microprocessor 1300 of FIG. 13, the CPU 1420 of FIG. 14, etc.) in one package, a DSP (e.g., the DSP 1422 of FIG. 14) in another package, a GPU in yet another package, and an FPGA (e.g., the FPGA circuitry 1400 of FIG. 14) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable cost-effective and lightweight moisture determination/characterization are disclosed herein. Further examples and combinations thereof include the following:

Example 1 includes an apparatus to determine a characteristic of moisture corresponding to a vehicle, the apparatus comprising a moisture sensor including first and second insulative layers, first and second electrodes between the first and second insulative layers, and a liquid transport material, wherein at least a portion of the liquid transport material is positioned between the first and second electrodes, and a resonance circuit electrically coupled to the first and second electrodes, the resonance circuit to measure a capacitance of the moisture sensor.

Example 2 includes the apparatus as defined in example 1, further including machine-readable instructions, and at least one processor circuit to be programmed by the machine-readable instructions to determine a degree of moisture present in a panel of the vehicle based on the capacitance.

Example 3 includes the apparatus as defined in example 2, wherein one or more of the at least one processor circuit to be programmed by the machine-readable instructions to direct a moisture control device based on the determined degree of moisture present.

Example 4 includes the apparatus as defined in any of examples 1 to 3, further including machine-readable instructions, and at least one processor circuit to be programmed by the machine-readable instructions to determine the capacitance of the moisture sensor with respect to time based on output from the resonance circuit, and determine a degree of moisture present in the vehicle based on the capacitance.

Example 5 includes the apparatus as defined in example 4, wherein one or more of the at least one processor circuit is to determine a slope of a curve corresponding to a parasitic capacitance over time for determination of a moisture level.

Example 6 includes the apparatus as defined in any of examples 4 or 5, wherein one or more of the at least one processor circuit is to determine an inflection point of a curve corresponding to the capacitance over time for determination of liquid absorption.

Example 7 includes the apparatus as defined in any of examples 1 to 6, wherein the first and second electrodes are electrically coupled to a capacitor of the resonance circuit.

Example 8 includes the apparatus as defined in any of examples 1 to 7, wherein the moisture sensor is embedded in or mounted to a thermal insulation blanket of a panel of the vehicle.

Example 9 includes the apparatus as defined in any of examples 1 to 8, further including a detection node spaced apart from the moisture sensor, the detection node to be electrically coupled to the moisture sensor for access thereto.

Example 10 includes at least one non-transitory machine-readable medium comprising machine-readable instructions to cause at least one processor circuit to at least determine a capacitance of a moisture sensor of a vehicle based on output from a circuit, the moisture sensor including (i) first and second electrodes between first and second insulative layers, and (ii) a liquid transport material, wherein at least a portion of the liquid transport material is positioned between the first and second electrodes, and determine a degree of moisture present in the vehicle based on the capacitance.

Example 11 includes the at least one non-transitory machine-readable medium as defined in example 10, wherein the machine-readable instructions are to cause one or more of the at least one processor circuit to direct a moisture control device based on the determined degree of moisture present.

Example 12 includes the at least one non-transitory machine-readable medium as defined in any of examples 10 or 11, wherein the machine-readable instructions are to cause one or more of the at least one processor circuit to determine the capacitance of the moisture sensor with respect to time based on output from an inductor-capacitor resonance circuit.

Example 13 includes the at least one non-transitory machine-readable medium as defined in example 12, wherein the machine-readable instructions are to cause one or more of the at least one processor circuit to determine a slope of a curve corresponding to the capacitance over time.

Example 14 includes the at least one non-transitory machine-readable medium as defined in any of examples 10 to 13, wherein the machine-readable instructions are to cause one or more of the at least one processor circuit to determine an inflection point of a curve corresponding to liquid absorption.

Example 15 includes the at least one non-transitory machine-readable medium as defined in any of examples 10 to 14, wherein the machine-readable instructions are to cause one or more of the at least one processor circuit to cause the moisture sensor to heat an insulation blanket of the vehicle.

Example 16 includes the at least one non-transitory machine-readable medium as defined in any of examples 10 to 15, wherein the machine-readable instructions are to cause one or more of the at least one processor circuit to identify an insulation blanket of the vehicle that exceeds a threshold degree of moisture based on the degree of moisture present.

Example 17 includes a method comprising determining, with a resonance circuit, a capacitance of a moisture sensor corresponding to a panel of a vehicle, the moisture sensor including (i) first and second electrodes between first and second insulative layers, and (ii) a liquid transport material, wherein at least a portion of the liquid transport material is positioned between the first and second electrodes, and determining a degree of moisture present in the panel based on the capacitance.

Example 18 includes the method as defined in example 17, further including causing the moisture sensor to heat an insulation blanket.

Example 19 includes the method as defined in example 18, wherein the moisture sensor is caused to heat the insulation blanket until the degree of moisture present is below a moisture threshold.

Example 20 includes the method as defined in any of examples 17 to 19, further including placing a handheld reader to contact a detection node spaced apart from the moisture sensor.

From the foregoing, it will be appreciated that example systems, apparatus, articles of manufacture, and methods have been disclosed that enable cost-effective and accurate moisture characterization and control. Examples disclosed herein can also effectively control moisture in vehicles and also diagnose any potential moisture issues in areas of a vehicle that might be difficult and/or laborious to access. Examples disclosed herein can be relatively easy to implement. Further, examples disclosed herein can be implemented in a weight-saving manner, which can be particularly advantageous in vehicle applications, such as aircraft, for example. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to determine a characteristic of moisture corresponding to a vehicle, the apparatus comprising:
a moisture sensor including:
first and second insulative layers;
first and second electrodes between the first and second insulative layers; and
a liquid transport material, wherein at least a portion of the liquid transport material is positioned between the first and second electrodes; and
a resonance circuit electrically coupled to the first and second electrodes, the resonance circuit to measure a capacitance of the moisture sensor.

2. The apparatus as defined in claim 1, further including:
machine-readable instructions; and
at least one processor circuit to be programmed by the machine-readable instructions to determine a degree of moisture present in a panel of the vehicle based on the capacitance.

3. The apparatus as defined in claim 2, wherein one or more of the at least one processor circuit to be programmed by the machine-readable instructions to direct a moisture control device based on the determined degree of moisture present.

4. The apparatus as defined in claim 1, further including:
machine-readable instructions; and
at least one processor circuit to be programmed by the machine-readable instructions to:
determine the capacitance of the moisture sensor with respect to time based on output from the resonance circuit; and
determine a degree of moisture present in the vehicle based on the capacitance.

5. The apparatus as defined in claim 4, wherein one or more of the at least one processor circuit is to determine a slope of a curve corresponding to a parasitic capacitance over time for determination of a moisture level.

6. The apparatus as defined in claim 4, wherein one or more of the at least one processor circuit is to determine an inflection point of a curve corresponding to the capacitance over time for determination of liquid absorption.

7. The apparatus as defined in claim 1, wherein the first and second electrodes are electrically coupled to a capacitor of the resonance circuit.

8. The apparatus as defined in claim 1, wherein the moisture sensor is embedded in or mounted to a thermal insulation blanket of a panel of the vehicle.

9. The apparatus as defined in claim 1, further including a detection node spaced apart from the moisture sensor, the detection node to be electrically coupled to the moisture sensor for access thereto.

10. At least one non-transitory machine-readable medium comprising machine-readable instructions to cause at least one processor circuit to at least:
determine a capacitance of a moisture sensor of a vehicle based on output from a circuit, the moisture sensor including: (i) first and second electrodes between first and second insulative layers; and (ii) a liquid transport material, wherein at least a portion of the liquid transport material is positioned between the first and second electrodes; and
determine a degree of moisture present in the vehicle based on the capacitance.

11. The at least one non-transitory machine-readable medium of claim 10, wherein the machine-readable instructions are to cause one or more of the at least one processor circuit to direct a moisture control device based on the determined degree of moisture present.

12. The at least one non-transitory machine-readable medium of claim 10, wherein the machine-readable instructions are to cause one or more of the at least one processor circuit to determine the capacitance of the moisture sensor with respect to time based on output from an inductor-capacitor resonance circuit.

13. The at least one non-transitory machine-readable medium of claim 12, wherein the machine-readable instructions are to cause one or more of the at least one processor circuit to determine a slope of a curve corresponding to the capacitance over time.

14. The at least one non-transitory machine-readable medium of claim 10, wherein the machine-readable instructions are to cause one or more of the at least one processor circuit to determine an inflection point of a curve corresponding to liquid absorption.

15. The at least one non-transitory machine-readable medium of claim 10, wherein the machine-readable instructions are to cause one or more of the at least one processor circuit to cause the moisture sensor to heat an insulation blanket of the vehicle.

16. The at least one non-transitory machine-readable medium of claim 10, wherein the machine-readable instructions are to cause one or more of the at least one processor circuit to identify an insulation blanket of the vehicle that exceeds a threshold degree of moisture based on the degree of moisture present.

17. A method comprising:
determining, with a resonance circuit, a capacitance of a moisture sensor corresponding to a panel of a vehicle, the moisture sensor including: (i) first and second electrodes between first and second insulative layers; and (ii) a liquid transport material, wherein at least a portion of the liquid transport material is positioned between the first and second electrodes; and
determining a degree of moisture present in the panel based on the capacitance.

18. The method as defined in claim 17, further including causing the moisture sensor to heat an insulation blanket.

19. The method as defined in claim 18, wherein the moisture sensor is caused to heat the insulation blanket until the degree of moisture present is below a moisture threshold.

20. The method as defined in claim 17, further including placing a handheld reader to contact a detection node spaced apart from the moisture sensor.
